(19) United States
(12) Patent Application Publication
(10) Pub. No.: US 2015/0088590 A1
(43) Pub. Date: Mar. 26, 2015

(54) REQUIREMENTS DEFINITION PROCESS AIDING SYSTEM

(71) Applicant: HITACHI, LTD., Tokyo (JP)

(72) Inventors: Haruhiko NISHIYAMA, Tokyo (JP); Kiyoshi KUMAGAI, Tokyo (JP); Nishio YAMADA, Tokyo (JP); Hideyuki KANUKA, Tokyo (JP); Masataka ARAKI, Tokyo (JP); Shigeru SUZUKI, Tokyo (JP)

(73) Assignee: HITACHI, LTD., Tokyo (JP)

(21) Appl. No.: 14/303,093

(22) Filed: Jun. 12, 2014

(30) Foreign Application Priority Data
Sep. 25, 2013 (JP) 2013-197693

(51) Int. Cl. G06Q 10/06

(52) U.S. Cl. CPC G06Q 10/06316
USPC 705/7.26

(57) ABSTRACT

A requirements definition aiding method causes a designer to become aware of study omissions by visualizing relations between measures and businesses. Measures that become a cause of reform of a business are previously described in relation to targets that change on business. Each business is previously described by using targets (resource, processing, and rule) handled on the business. Dependence relations and exclusive relations are previously defined as relations between measures. Relations between measures and businesses are extracted by using targets that become common in measures and businesses. A measure that is not assigned to a business, insufficient application of a measure in a dependence relation, and an application contradiction of a measure in an exclusive relation are extracted.

### INCORPORATION BY REFERENCE

The present application claims priority from Japanese application JP2013-197693 filed on Sep. 25, 2013, the content of which is hereby incorporated by reference into this application.

### BACKGROUND OF THE INVENTION

The present invention relates to aid of an upper design process in system development, and in particular to a method for reducing omissions and oversights of examinations when applying a new measure.

As a conventional technique concerning aid of an upper design process in system development, there is JP-A-2007-241871 (Patent Literature 1). Patent Literature 1 provides a design aid system that facilitates finding malfunctions in design and aids the design. It is a technique for identifying a design part on a document relating to a design part on the basis of design contents acquired every design part and facilitating designer's confirmation.

### SUMMARY OF THE INVENTION

In recent years, information of business that supports root undertaking of enterprises has been advanced. The business implemented on these systems does not continue to be used as it is once developed, but a reform for following a market change is also needed. In other words, it is necessary to apply a new measure to a business that is now under execution (AsIs business) and reform the business to a business in the next period (ToBe business). With the advance of the business, it also becomes necessary to update relating systems.

At this time, in the initial stage of the requirements definition process, contents of the new measure and the ToBe business are indefinite or insufficient in details in many cases. It is often impossible to clearly specify relations between them. When designing the ToBe business, therefore, reflection omission of the new measure occurs. Without revelation of this, advance to a lower process such as detailed design, mounting, or a test is conducted. Eventually, a return work occurs in some cases. For example, when applying a measure “conducting strict intention confirmation of the person himself or herself” (specifically, contents confirmation using a document and sealing), it is unknown in the initial analysis stage of business, in which business such a scene appears, and reflection of this measure is omitted. Furthermore, as another example, when applying a measure “electronic document” in addition to the above-described measure, presence and absence of a “blank form” (a measure that needs a blank form for sealing and a measure that makes the blank form itself electronic and that makes the blank form unused) contradict to each other.

This means that “conducting strict intention confirmation of the person himself or herself” and “electronic document” cannot be applied to the same business, In the initial stage of design, however, definition of the measure and definition of the business are vague and consequently it cannot he made clear whether to apply a plurality of contradicting measures to the same business together.

Here, terms used in the present specification will be defined. In general, “business” is a procedure on work. More specifically, however, the “business” can be described by using a flow of “processing” for a “resource” handled on the business and using a “rule” at the time when executing the processing. Furthermore, the “measure” is a factor that reforms an AsIs business to a ToBe business. In other words, the “measure” can be described as a change for “target (resource, processing, or rule) of a business.

In order to solve the above-described problem, the present invention aids judgment of suitability of a measure by managing the relevancy between the measure and the business. For this purpose, the relation between the business function and a new measure is automatically generated, and a reflection omission of a measure and a sorting out omission of a business function are detected on the basis of previously defined dependence/exclusive relations among measures.

Furthermore, the following forms are also included in the present invention. A measure and a business are described by using information that is the target. A matrix is created between a measure and a business that handle a common “target.” List up is thus conducted. It is also possible to cause a designer to become aware that there is a possibility of a relation by displaying a result thereof on a screen or the like.

Furthermore, in the relation between measures and businesses, measures having no relations with a business are displayed on the screen. This indicates that there is a possibility that the measures will not be reflected. In addition, a dependence relation (when applying a certain measure A, a different measure B is also applied at the same time) and an exclusive relation (a measure A and a measure C are not applied to the same business at the same time) are previously defined between measures. If it is detected that one of measures in the dependence relation is applied to a business whereas the other is not applied to the same business, it is displayed on the screen that application of the measure is insufficient. Furthermore, if it is detected that both measures in an exclusive relation are applied to the same business, it is displayed on the screen that application of measures contradicts.

According to the present invention, it becomes possible to manage relations between businesses and measures with higher precision and it becomes possible to aid confirmation of consistency thereof.

Other objects, features and advantages of the invention will become apparent from the following description of the embodiments of the invention taken in conjunction with the accompanying drawings.

### BRIEF DESCRIPTION OF THE DRAWINGS

FIG. 1 shows a general configuration of a function according to an embodiment of the present invention;

FIG. 2 shows an example of a data structure recorded as a term dictionary;

FIG. 3 shows an example of a data structure for recording measures;

FIG. 4 shows an example of a display method on a screen for displaying relations among measures;

FIG. 5 shows an example of a data structure for recording businesses;

FIG. 6 shows an example of a data structure for holding and displaying relations between measures and businesses;

FIG. 7 shows a flow of processing for extracting relations between measures and businesses and creating a matrix;

FIG. 8 shows a flow of processing for extracting study omissions in the relations between measures and businesses on the basis of dependence relations between measures; and

FIG. 9 shows a flow of processing for extracting study omissions in the relations between measures and businesses on the basis of exclusive relations between measures.

### DESCRIPTION OF THE EMBODIMENT

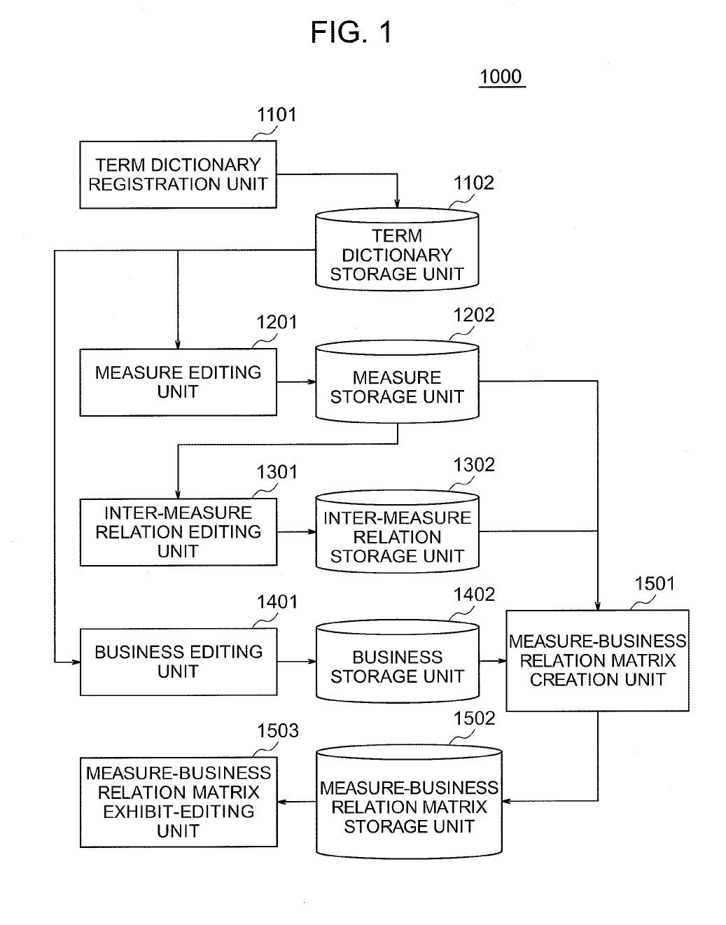

Hereafter, an embodiment of the present invention will be described with reference to the drawings. As shown in FIG. 1, a requirements definition process aiding apparatus 1000 includes a term dictionary registration unit 1101, a term dictionary 1102, a measure editing unit 1201, a measure storage unit 1202, an inter-measure relation editing unit 1301, an inter-measure relation storage unit 1302, a business editing unit 1401, a business storage unit 1402, a measure-business relation matrix creation unit 1501, a measure-business relation matrix storage unit 1502, and a measure-business relation matrix exhibit-editing unit 1503. By, the way, (1) an arrow in FIG. 1 indicates a data flow between components. (2) Furthermore, each unit is implemented by software (a program). The requirements definition process aiding apparatus 1000, which is a computer, executes computation in a computation device such as a CPU. As a result, functions of respective units are achieved.

The term dictionary registration unit 1101 is used in the measure editing unit 1301 and the business editing unit 1401 to make targets of business input in the respective places common. In other words, terms in use are prevented from diverging by registering measures and businesses by use of only the “targets” registered here.

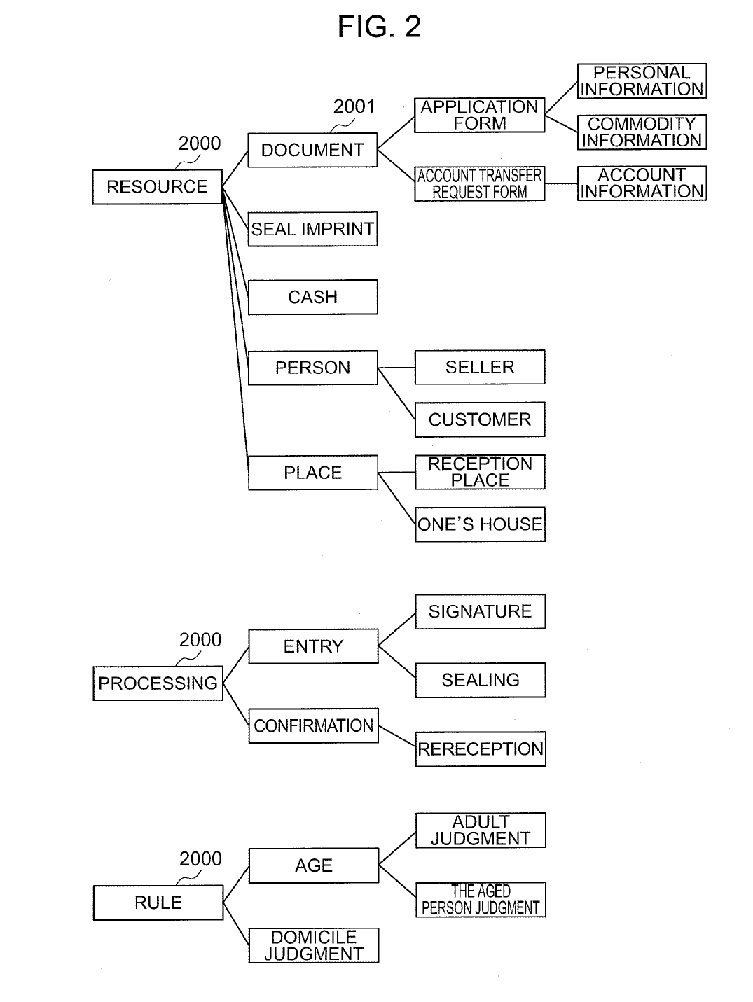

FIG. 2 shows a tree for storing a term dictionary stored in the term dictionary storage 1102. Terms are defined hierarchically with terms indicating a category 2000 designated as root nodes. The present embodiment is described by using three kinds, i.e., “resource,” “processing,” and “rule” as categories. However, expansion is possible by registering categories here. Respective nodes 2001 in the hierarchy are utilized as terms when defining measures and businesses. As for each node, a term indicating the target may be used as it is. Or an ID which uniquely indicates a node may be linked with a term and managed. In a case where terms are stored by using IDs, the IDs are used whenever referring to the terms thereafter. Furthermore, these kinds of information can be prepared by inputting and editing by use of an editor capable of editing information of a tree structure such as the XML (Extensible Markup Language) editor.

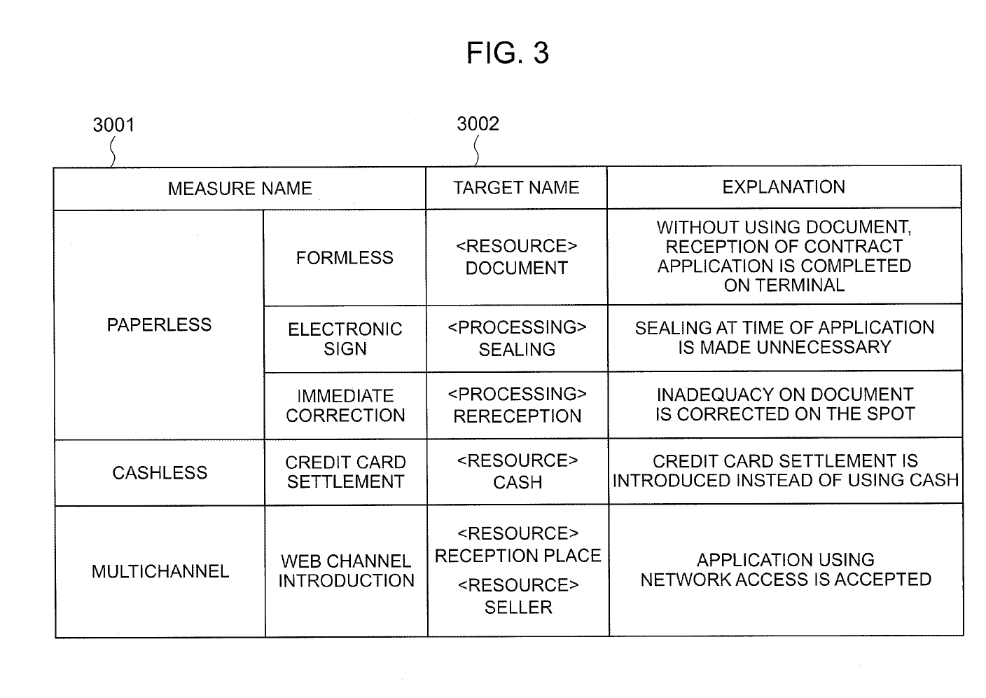

FIG. 3 shows a table for storing information concerning measures stored in the measure storage unit 1202. The information is stored by using a measure name 3001 and a target name 3002. The measure name 3001 permits hierarchical recording. As for the information of measures, information having a similar structure is created by using spread sheet software or the like and the measure editing unit 1201 reads the information and records the information into the measure storage unit 1202.

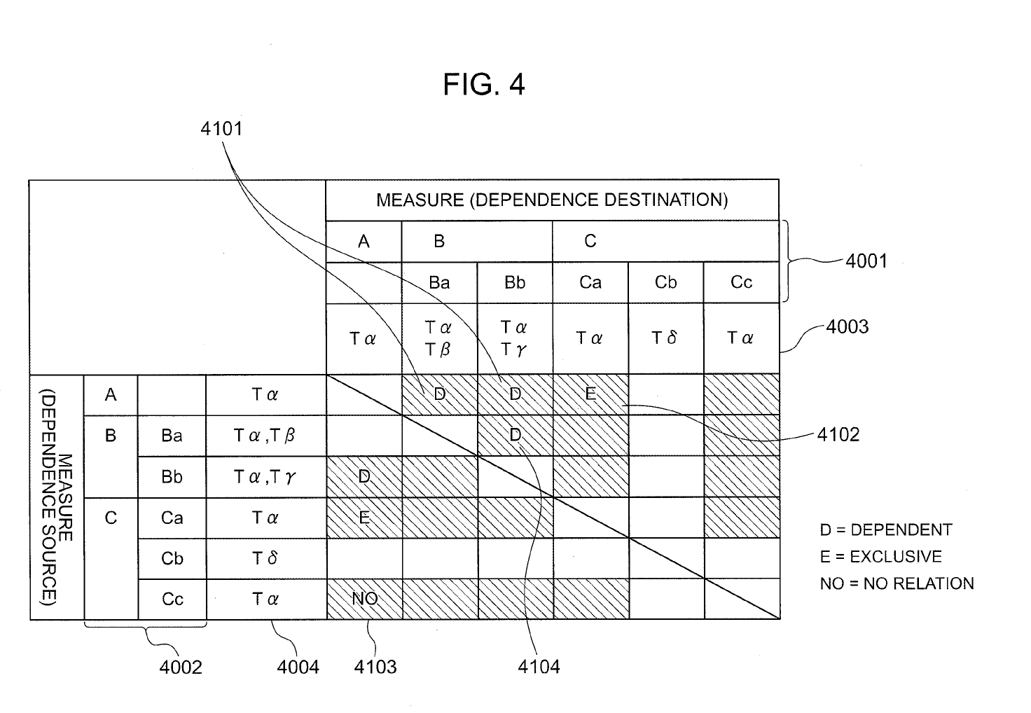

FIG. 4 shows a screen image of the inter-measure relation editing unit 1301. When editing inter-measure relations, measures recorded in the measure storage unit 1202 are arranged and displayed in header fields in a row and a column in a table (4001, 4002). In addition, target names of respective measures may also be displayed simultaneously (4003, 4004). The inter-measure relation editing unit 1301 displays pertinent cells with highlight, for measures handling the same target. In the illustrated example, “measure A” is a measure that changes “target Tα.” At this time, for “measure Ba,” “measure Bb,” “measure Ca,” and “measure Cc” which changes the same target, crossing cells are displayed with highlight. The designer judges study of relations to be indispensable for the highlighted cells. As for relations between measures, “dependence relation,” “exclusive relation,” and “no relation” are set. In the illustrated example, in a case where the “measure Ba” and the “measure Bb” are also executed always whenever the “measure A” is executed, flag D (“dependent”) is entered into crossing cells (4101). More specifically, when applying a measure “form-less (a document such as an application form is not used)” to a certain business, a measure “electronic sign (sealing at the time of application is electronically executed)” is also applied simultaneously.

Furthermore, in a case where there is an exclusive relation that the “measure Ca” is not executed when the “measure A” is executed, flag E (“exclusive”) is entered in a crossing cell (4102). Specifically, when applying a measure “form-less” to a certain business, a measure “continuation of document procedure (a business using a document such as an application form is followed)” is not applied to the same business.

In a case where there is no dependence relation, a flag NO (“no relation”) is entered (4103). By the way, a study omission can be prevented by accepting designer's entering of relations into the highlighted cells.

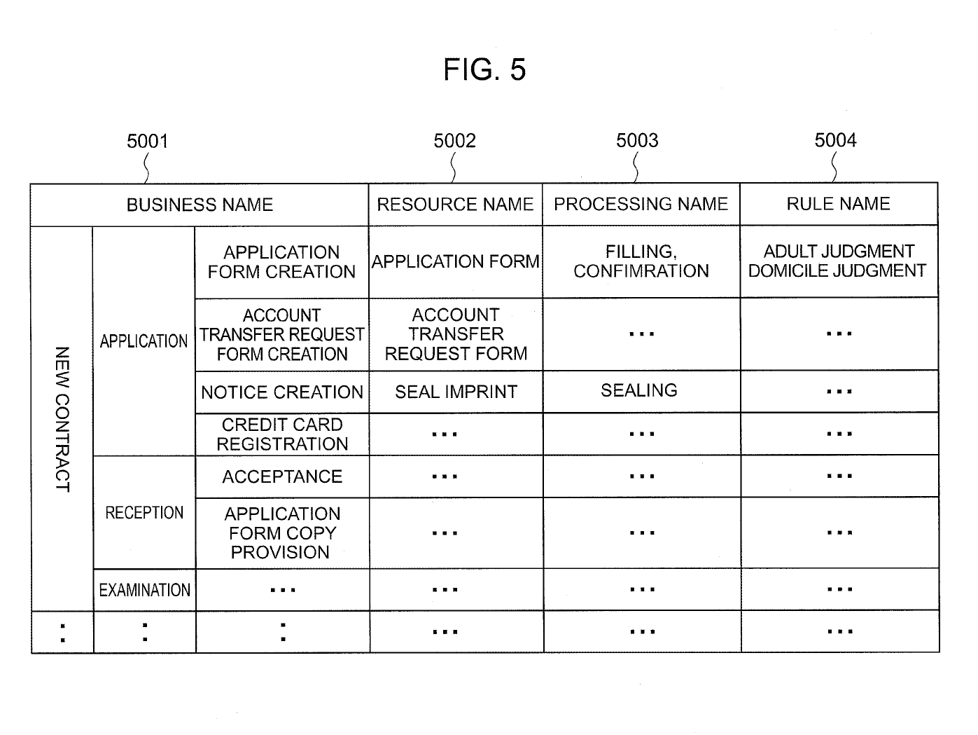

FIG. 5 shows a table for storing information concerning businesses stored in the business storage unit 1402. A business name 5001, a resource name 5002, a processing name 5003, and a rule name 5004 are target names specifying a business, a resource, processing, and a rule, respectively. As for the information of businesses, information having a similar structure is created by using spread sheet software or the like and the business editing unit 1401 reads the information and records the information into the business storage unit 1402.

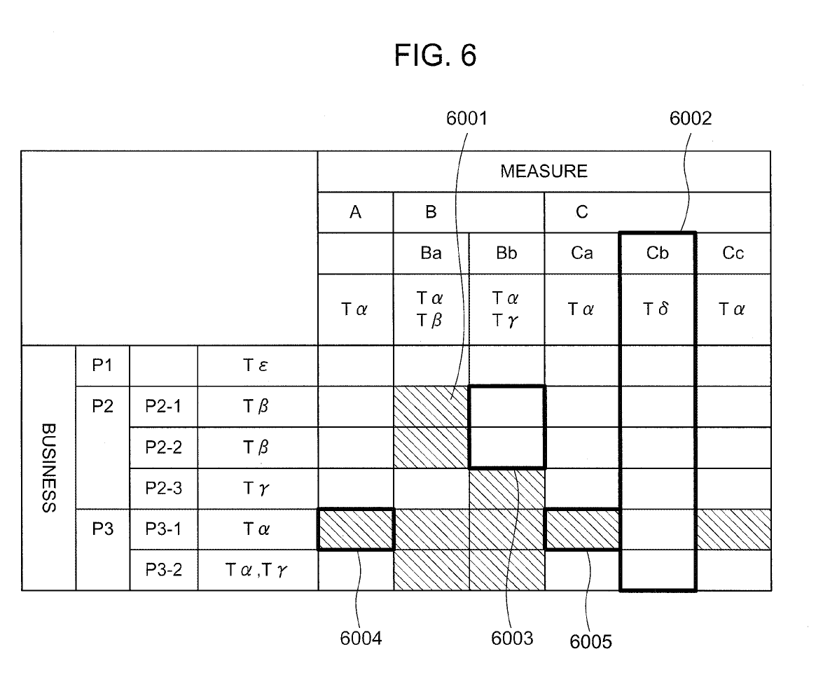

FIG. 6 shows a matrix of correspondence relations between measures and businesses created by the measure-business relation matrix creation unit 1501 and stored in the measure-business relation matrix storage unit 1502.

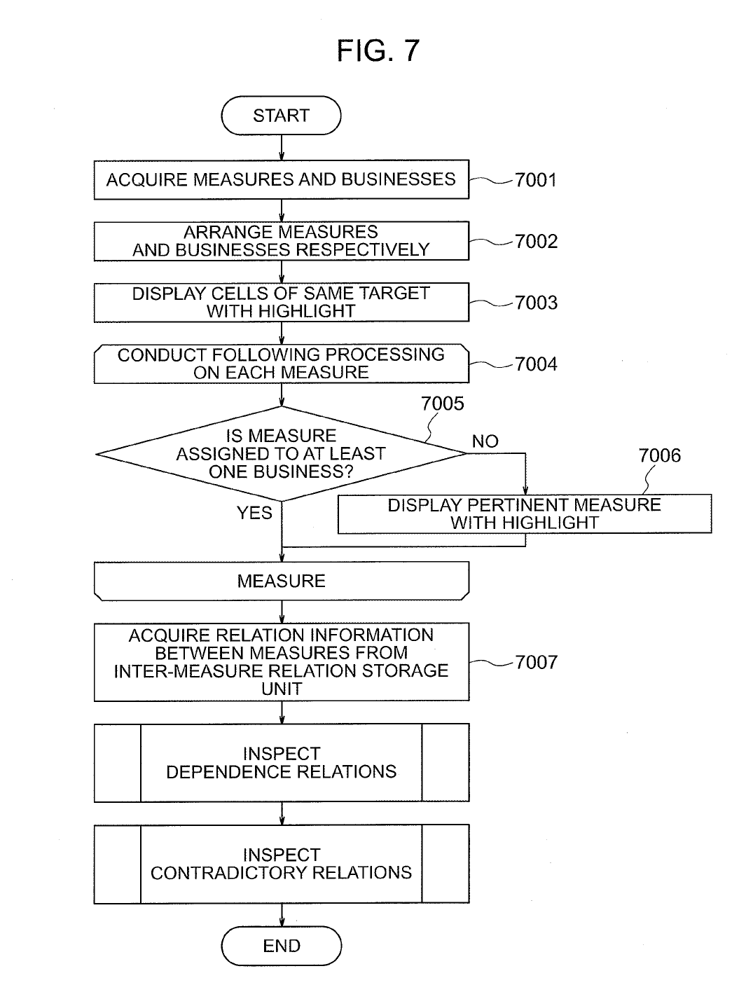

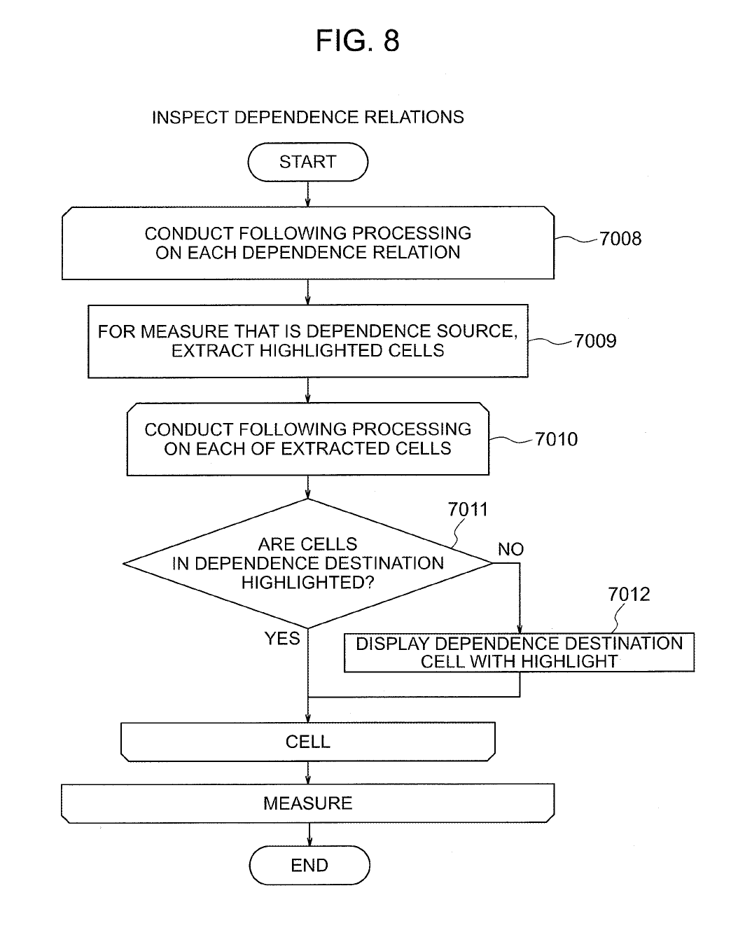

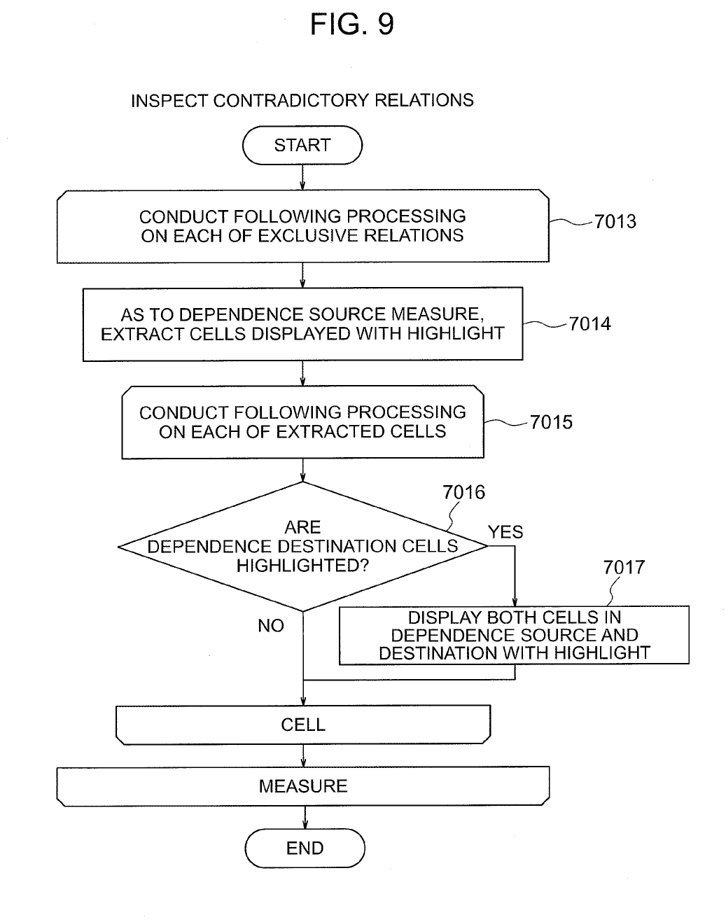

FIGS. 7 to 9 are flow charts showing how the measure-business relation matrix creation unit 1501 creates the matrix shown in FIG. 6. At step 7001, the measure-business relation matrix creation unit 1501 acquires information of measures and businesses from the measure storage unit 1202 and the business storage unit 1402, respectively. At step 7002, the measure-business relation matrix creation unit 1501 arranges the acquired measures and businesses respectively into rows and columns of the matrix, and displays the matrix.

In the image shown in FIG. 6, target names are also displayed for description. However, the target names may not be displayed.

At step 7003, the measure-business relation matrix creation unit 1501 extracts a measure and a business that handle the same target out of measures and businesses, and displays pertinent cells with highlight. In an example shown in FIG. 6, “measure Ba” and “processing P2-1” handle “target Tβ.” Therefore, a cell at a cross point is displayed with highlight (6001).

At step 7004 and subsequent steps, a reflection omission of a measure is extracted. Out of measures in the lowest layer (measures defined in the tree form having no child nodes), a measure that does not correspond to any business (that does not have a highlighted cell) is detected (step 7005). For the detected measure, a column thereof is displayed with highlight (step 7006). In the example shown in FIG. 6, “measure Cb” is not reflected to any business. Therefore, the column of “measure Cb” is displayed with highlight (6002).

At step 7007 and subsequent steps, a setting omission in dependence relations between measures is detected. At step 7007, relation information between measures is acquired from the inter-measure relation storage unit 1302. At step 7008, dependence relations are extracted. The following processing is conducted for each dependence relation. At step 7009, for a measure that is a dependence source in a dependence relation that is a processing target, highlighted cells are extracted. As for the extracted cells, it is determined whether cells in the dependence destination are highlighted (step 7011). If the cells in the dependence destination are not displayed with highlight, the cells in the dependence destination are displayed with highlight (step 7012).

In information recorded in the inter-measure relation storage unit 1302 as shown in FIG. 4, there is a relation of “dependence” between “measure Ba” and “measure Bb” (4104). This indicates that it is necessary to execute the “measure Bb” when executing the “measure Ba.” On the other hand, in FIG. 6, in businesses to which the “measure Ba” is applied, there is a place where the measure Bb” is not applied (6003). In the step 7011, these cells are detected.

Furthermore, processing is conducted for all exclusive relations as well. At step 7013, exclusive relations are extracted. Processing described hereafter is conducted for each of the exclusive relations. At step 7014, as regards a measure that is a dependence source in an exclusive relation that is a processing target, places where cells are displayed with highlight are extracted. As for an extracted cell, it is determined whether a cell of dependence destination is displayed with highlight (step 7016). If the cell of dependence destination is displayed with highlight, both cells of dependence source and dependence destination are displayed with highlight (step 7017).

In information recorded in the inter-measure relation storage unit 1302 as shown in FIG. 4, there is a relation of “exclusion” between “measure A” and “measure Ca” (4102). This indicates that the “measure A” and the “measure Ca” cannot be applied to the same business, On the other hand, it is indicated in FIG. 6 that the “measure A” and the “measure Ca” are applied to “business P3-1” simultaneously (6004, 6005). At the above-described step 7016, these cells are detected.

As described heretofore, the designer can extract omitted dependence relations and exclusive relations from dependence relations and exclusive relations among measures and display the omitted dependence relations and exclusive relations on the screen.

Furthermore, in the foregoing description, all marked places have been described as “displayed with highlight.” By changing the color, line thickness, pattern, and the like at respective highlighting steps, however, it can be expressed clearly at which step highlight display has been conducted. As a result, the designer can be informed what cause has brought about highlighting. As for a place detected here, there is a possibility of an extraction omission of a measure or a business itself, a detailing omission, a target setting omission, or a target detailing omission. It becomes possible for the designer to judge a study omission place by referring to the display of processing results without manually arranging all relations between measures and businesses.

By the way, in the embodiment of the present invention, there are two forms differing in whether there are the term dictionary registration unit 1101 and the term dictionary storage unit 1102 shown in FIG. 1. In the form that has not the term dictionary registration unit 1101 and the term dictionary storage unit 1102, there is a difference only in that terms are not regulated and it is determined whether the targets are the same by referring to only character strings entered as target names.

According to the present embodiment described heretofore, it is not necessary for the designer to verify all combinations, but the designer need only confirm only extracted combinations. As a result, burden on design can be lightened. In other words, the designer can lighten the burden of checking study omissions on design by reviewing businesses and measures to which only a measure having no assignment to businesses is applied. Furthermore, the designer can lighten the burden of checking omissions on design by reviewing contents of measures and businesses and making them detailed suitably as to only combinations of measures and businesses detected from dependence relations and exclusive relations.

It should be further understood by those skilled in the art that although the foregoing description has been made on embodiments of the invention, the invention is not limited thereto and various changes and modifications may be made without departing from the spirit of the invention and the scope of the appended claims.

1. A requirements definition process aiding method for aiding a requirements definition process when constructing a system for executing predetermined businesses, the requirements definition process aiding method comprising:
previously storing dependence/exclusive relations between measures in a storage device as regards the businesses and measures concerning the businesses;
generating relations of new measures applied to the business on the basis of contents in the storage device; and
extracting problems concerning the measures on the basis of the generated relations and the dependence/exclusive relations.

2. The requirements definition process aiding method according to claim 1, wherein the extracting processing extracts reflection omissions of the measures and sorting out omissions of business functions as the problems.

3. The requirements definition process aiding method according to claim 1, wherein
the storage device stores target information that changes by applying the measure and that is supplied as the measure, and stores target information handled in the business and supplied as the business, and
the extracting processing identifies corresponding relations between the measures and the businesses on the basis of target information that becomes common to the measures and the business, and extracts a measure that is not assigned to at least one business.

4. The requirements definition process aiding method according to claim 1, wherein
the storage device stores dependence relations between measures, and
the extracting processing extracts a relation between measures and a business in which one of measures in a dependence relation relates to a predetermined business whereas the other of measures in the dependence relation does not relate to the predetermined business.

5. The requirements definition process aiding method according to claim 1, wherein
the storage device stores exclusive relations between measures, and
the extracting processing extracts a relation between measures and a business in which one of measures in an exclusive relation relates to a predetermined business whereas the other of measures in the exclusive relation also relates to the predetermined business simultaneously.

6. A requirements definition process aiding apparatus for aiding a requirements definition process when constructing a system for executing predetermined businesses, the requirements definition process aiding apparatus comprising:
a storage unit for previously storing dependence/exclusive relations between measures as regards the businesses and measures concerning the businesses;
a generation unit for generating relations of new measures applied to the business on the basis of contents in the storage unit; and
an extraction unit for extracting problems concerning the measures on the basis of the generated relations and the dependence/exclusive relations.

7. The requirements definition process aiding apparatus according to claim 6, wherein the extraction unit extracts reflection omissions of the measures and sorting out omissions of business functions as the problems.

8. The requirements definition process aiding apparatus according to claim 6, wherein
the storage unit stores target information that changes by applying the measure and that is supplied as the measure, and stores target information handled in the business and supplied as the business, and
the extraction unit identifies corresponding relations between the measures and the businesses on the basis of target information that becomes common to the measures and the business, and extracts a measure that is not assigned to at least one business.

9. The requirements definition process aiding apparatus according to claim 6, wherein
the storage unit stores dependence relations between measures, and
the extraction unit extracts a relation between measures and a business in which one of measures in a dependence relation relates to a predetermined business whereas the other of measures in the dependence relation does not relate to the predetermined business.

10. The requirements definition process aiding apparatus according to claim 6, wherein
the storage unit stores exclusive relations between measures, and
the extraction unit extracts a relation between measures and a business in which one of measures in an exclusive relation relates to a predetermined business whereas the other of measures in the exclusive relation also relates to the predetermined business simultaneously.
